(19) United States
(12) Patent Application Publication
(10) Pub. No.: US 2004/0112188 A1
(43) Pub. Date: Jun. 17, 2004

(54) Method for press punching a hole in sheet metal and press die

(76) Inventor: Masatoshi Oishi, Hiroshima (JP)

Correspondence Address: NIXON & VANDERHYE, PC, 1100 N GLEBE ROAD, 8TH FLOOR, ARLINGTON, VA, 22201-4714, US

(21) Appl. No.: 10/320,708

(22) Filed: Dec. 17, 2002

(51) Int. Cl. B26D 1/00; B26D 3/00; B26F 1/14

(52) U.S. Cl. 83/13; 83/684

(57) ABSTRACT

A punch unit for a press die for punching a hole in sheet metal includes: a piercing punch provided with a sharp projection; a plunger for pressing the piercing punch; a cylinder for supporting the piercing punch and the plunger slidably in a punching direction; and a coil spring for retracting the piercing punch and the plunger. Also disclosed are a press die for punching a hole in sheet metal and a punching method using the punch unit.

### BACKGROUND OF THE INVENTION

1. Field of the Invention

The present invention relates to a method for punching a hole in a sheet metal by press working and a press die.

2. Description of the Related Art

Conventionally, in a case where a hole is punched in a sheet metal by press working, it is the general practice to place a workpiece on a piercing die having a punching hole and subsequently to lower an upper die having a piercing punch so as to effect shearing work with respect to the workpiece by the punch and the die.

In the case where work is effected using such a conventional technique, it is normally necessary to control the clearance between the piercing punch and the piercing die to within plus 0.01 millimeter and minus 0.01 millimeter. If this clearance cannot be maintained, burrs can occur in the workpiece, or defects of punching edges of the piercing punch and the piercing die or the breakage of the piercing punch can occur owing to the interference between the piercing punch and the piercing die.

To prevent this problem from occurring, large cost of die fabrication and long periods of die design and fabrication are conventionally required, involving such as the planning of a die structure which makes it possible to ensure the axial accuracy of the piercing punch and the piercing die with high accuracy as well as manual operations for enhancing the die fabrication accuracy.

In addition, in a case where a hole is punched in a plate surface which is inclined with respect to the press working direction, since the piercing punch tends to escape in the direction of inclination to make it impossible to maintain the clearance, and since the breakage of the punch occurs, a slide cam mechanism is conventionally provided, and the punch is held by this slide cam mechanism to force out the punch in a direction different from the pressing direction.

Conventionally, as the aforementioned slide cam mechanism, if broadly classified, two structures have been devised.

One is a structure to hold a cam slider by a pad incorporated in an upper die holder, and this structure is effective to simplify the die structure. However, since this pad is held on the workpiece placed on the lower die, variation can occur in the position where the pad is held with respect to the lower die because of the variation of configurations of workpieces.

For this reason, this structure is not used since it is difficult to maintain the clearance between the piercing punch and the die necessary for the conventional punching method.

Accordingly, another slide cam mechanism is conventionally used in which a cam slider is mounted on the upper die holder or the lower die.

However, with this other slide cam mechanism, since not only is this cam mechanism itself expensive, but a multiplicity of dies are required for manufacturing a single pressed part, since it is impossible to effect the simultaneous cutting work of outer peripheral edges of a pressed part and the simultaneous piercing work of a plurality of different surfaces.

In addition, in the process of manufacturing pressed parts, there is a problem in that large repairing cost is involved for maintaining the axial accuracy of the piercing punch and the piercing die.

JP-A-11-129041 discloses a press die in which, instead of the piercing punch, a pressure medium typified by urethane rubber is pressed to punch a hole in a workpiece, to solve the above problems.

In the press die disclosed in that document, tension is applied to the workpiece at the hole portion of the piercing die buried in the lower die by means of the pressure applied to the pressure medium, and the workpiece is thereby fractured by an outer peripheral edge portion of the hole portion of the die so as to obtain a hole.

However, in the case where pressing is effected by the press die disclosed in that document, after the workpiece has been fractured by a portion of the outer periphery of the hole portion of the piercing die, the pressure applied to the pressure medium escapes to the fractured space, and the pressure medium is released. Therefore, even if further pressurization is effected, it is impossible to transmit tension for punching a hole in the workpiece, with the result that it is impossible to fracture over the entire region of the outer periphery of the hole portion of the piercing die, making it impossible to obtain a satisfactory hole configuration. In addition, there is another problem in that the pressure medium typified by urethane rubber is shaved off by the sharp edge portion of the piercing die hole, so that the pressure medium lacks durability.

### SUMMARY OF THE INVENTION

The present invention has been devised in view of the above-described circumstances, and its object is to provide a punch unit which allows a certain degree of axial offset between the piercing punch and the piercing die, permits high-quality punching reliably without using a complex slide cam mechanism, improves durability over the conventional art, and thereby makes it possible to lower the die fabrication cost, shorten the period of die fabrication, and reduce the die repairing cost, as well as a press die and a punching method using this punch unit.

To this end, in accordance with a first aspect of the present invention there is provided a punch unit for a press die for punching a hole in sheet metal, comprising: a piercing punch provided with a sharp projection; a plunger for pressing the piercing punch; a cylinder for supporting the piercing punch and the plunger slidably in a punching direction; and a coil spring for retracting the piercing punch and the plunger.

In the above-described punch unit, preferably, the sharp projection is provided on a surface opposing a piercing die buried in a lower die, the cylinder is adapted to be fitted in a pad of an upper die, and an outer peripheral edge portion of a tip of the piercing punch provided with the sharp projection is rounded.

In addition, in accordance with a second aspect of the present invention there is provided a press die for punching a hole in sheet metal, comprising: an upper die having a pad; a lower die in which a piercing die is buried; a cylinder fitted in the pad; a piercing punch supported slidably in a punching direction by the cylinder and disposed in face-to-face relation to the piercing die; a plunger for pressing a head of the piercing punch, the plunger being supported slidably in the punching direction by the cylinder; and a coil spring disposed in the cylinder to retract the piercing punch and the plunger, the plunger having a head pressed by one of an upper die holder and a plate secured to the upper die holder so as to force out the piercing punch.

In the press die for punching a hole in the present invention, the piercing die may be buried in an inclined surface of the lower die.

In addition, in accordance with a third aspect of the present invention there is provided a method for press punching a hole in sheet metal, comprising the steps of: causing a workpiece to be pressed by a piercing punch which is held by an upper die and which has a smaller diameter than in a case where it is used in shearing work with respect to a diameter of a hole of a piercing die buried in a lower die, and has at a tip thereof at least one sharp projection for piercing the workpiece, an outer peripheral edge portion of the tip where the sharp projection is provided being rounded, so as to punch a pierced hole in the workpiece by the sharp projection; and further pressing the piercing punch in a state in which the lateral movement of the workpiece in a hole portion of the piercing die is restricted by the sharp projection and the pierced hole, so as to fracture the workpiece by a peripheral edge portion of the hole portion of the piercing die, thereby forming in the workpiece a hole having substantially the same configuration as that of the hole of the piercing die.

The above-described method preferably further comprises the step of: forming a hole in a plate surface of the workpiece having an inclination with respect to a direction in which the workpiece is pressed.

In accordance with the present invention, the planning of a complex die structure for ensuring the axial accuracy of the piercing punch and the piercing die and manual operations for enhancing the die fabrication accuracy become unnecessary. Thus it is possible to reduce the number of die fabrication steps and shorten periods of die design and fabrication.

In addition, in accordance with the present invention, it is unnecessary to use a complex and expensive slide cam structure in a case where punching work is effected with respect to a plate surface of a workpiece which is inclined with respect to the pressing direction. Since the fabrication cost associated with the slide cam and the operation of aligning the piercing punch and the piercing die are not required, it is possible to reduce the die fabrication cost and shorten the period of die fabrication.

Furthermore, in accordance with the present invention, since the slide cam structure which is mounted on the upper die holder or the lower die is unnecessary, it is possible to simultaneously effect punching in a plurality of different plate surfaces of the workpiece, and the peripheral edge cutting work and punching work can be effected simultaneously. Therefore, the number of press working steps can be reduced substantially, and the number of dies can be decreased, so that it is possible to lower the die cost and shorten the periods of die design and fabrication.

In addition, in accordance with the present invention, it is possible to reduce the repairing cost for correcting axial offset between the piercing punch and the piercing die occurring due to the wear of slide surfaces of upper and lower dies and cam slide surfaces at the time of mass production.

Hereafter, a description will be given of the present invention with reference to the embodiments shown in the drawings. It should be noted that the present invention is not limited to these embodiments.

### BRIEF DESCRIPTION OF THE DRAWINGS

FIG. 1 is a cross-sectional view illustrating an embodiment of a punching method;

FIG. 2 is a cross-sectional view illustrating the embodiment of the punching method;

FIG. 3 is a cross-sectional view illustrating the embodiment of the punching method;

FIG. 4 is a cross-sectional view illustrating a press die for punching;

FIG. 5 is a cross-sectional view illustrating a press die for punching; and

FIG. 6 is a cross-sectional view illustrating the entirety of FIG. 5.

### DESCRIPTION OF THE PREFERRED EMBODIMENTS

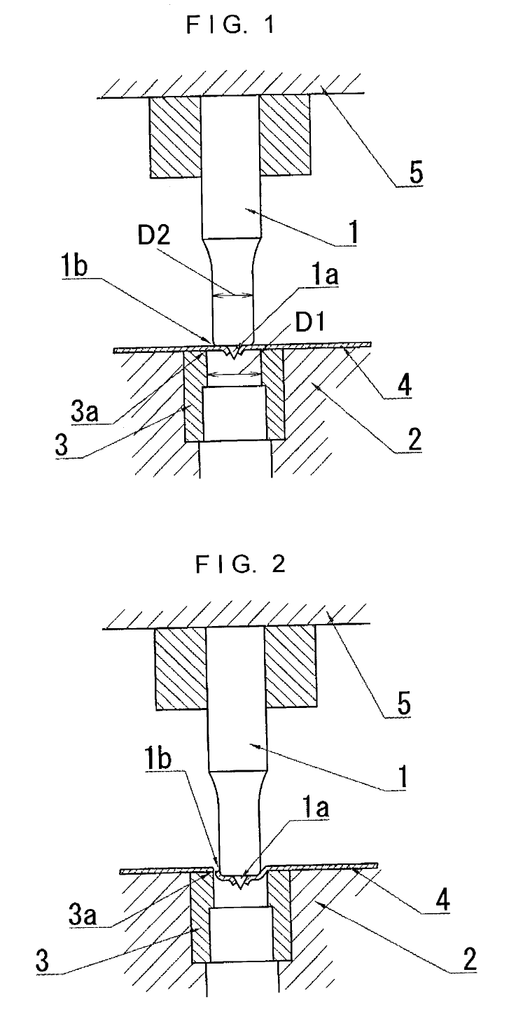

In FIGS. 1 to 3, a press die for punching is comprised of a piercing die 3 buried in a lower die 2 as well as a piercing punch 1 held by an upper die 5. The piercing punch 1 has a smaller diameter D2 than in a case where it is used in shearing work with respect to a diameter D1 of the hole of the piercing die 3, and the piercing punch 1 has at its tip a sharp projection 1a for piercing a workpiece 4. In such a piercing punch 1, an outer peripheral edge portion 1b of the tip where the sharp projection 1a is provided is rounded.

In a case where punching is effected by the press die for punching shown in FIGS. 1 to 3, the workpiece 4 formed of sheet metal is placed on the lower die 2 including the piercing die 3, and as the upper die 5 is lowered, the piercing punch 1 is pressed against the workpiece 4. Thus, as shown in FIG. 1, in the initial period of working, the sharp projection 1a provided on the piercing punch 1 is first brought into contact with the workpiece 4, thereby forming a pierced hole in the workpiece 4 by the sharp projection 1a of the piercing punch 1. Further, as shown in FIG. 2, as the upper die 5 is further lowered, the piercing punch 1 is pressed into the piercing die 3, thereby causing the rounded edge portion 1b of the piercing punch 1 to come into contact with the workpiece 4. At the same time, in a state in which the lateral movement of the workpiece 4 in the hole portion of the piercing die 3 is restricted by the sharp projection 1a and the pierced hole, tension is applied to a portion of the workpiece 4 corresponding to the hole portion of the piercing die 3. Then, the piercing punch 1 is further pressed to bring the workpiece 4 to a limit of fracture, and a portion of the workpiece 4 is thereby fractured by an outer peripheral edge portion 3a of the hole portion of the piercing die 3.

At this time, the tension imparted to the workpiece 4 would be normally released, but in the present invention the tension imparted to the workpiece 4 is held by the sharp projection 1a provided on the piercing punch 1 and the pierced hole punched in the initial period of working.

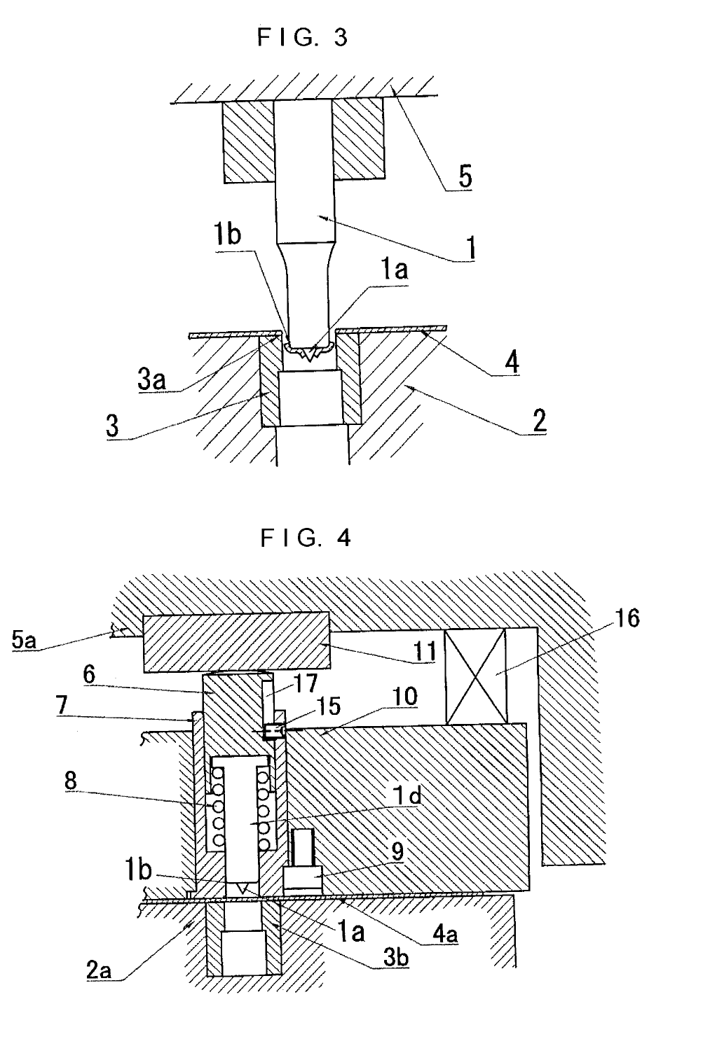

As shown in FIG. 3, as the upper die 5 is further lowered, the piercing punch 1 is further pressed into the piercing die 3, the workpiece 4 is fractured by the entire periphery of the inner peripheral edge portion 3a of the hole portion of the piercing die 3, with the result that a hole having substantially the same configuration as that of the hole of the piercing die 3 is formed in the workpiece 4.

A press die in accordance with another embodiment shown in FIG. 4 is comprised of: a punch unit including a piercing punch 1d which is disposed in face-to-face relation to a piercing die 3b buried in a lower die 2a and is provided with the sharp projection 1a, a plunger 6 for pressing the piercing punch 1d, a cylinder 7 for supporting the piercing punch 1d and the plunger 6 slidably in the punching direction, a coil spring 8 for retracting or pressing back the piercing punch 1d and the plunger 6, and a stopper 15 for prohibiting the pressing back of the piercing punch 1d and the plunger 6 by the coil spring 8 by more than a fixed length; a bolt 9 for fixing the cylinder 7 as fitted in a pad 10; and a plate 11 fixed to an upper die holder 5a for the purpose of pressing the plunger 6.

The sharp projection 1a is provided on the surface of the piercing punch 1d opposing the piercing die 3b, and the outer peripheral edge portion 1b of the tip of the piercing punch 1d provided with the sharp projection 1a is rounded. The upper die includes the upper die holder 5a, the pad 10, the plate 11, and a resilient member 16. The pad 10 is connected to the upper die holder 5a with the resilient member 16 interposed therebetween. The stopper 15 is threadedly secured to the cylinder 7, and its one end portion faces an axial groove 17 provided in the plunger 6.

Accordingly, the press die for punching a hole in the sheet metal shown in FIG. 4 is arranged such that the piercing punch 1d opposing the piercing die 3b buried in the lower die 2a as well as the plunger 6 for pressing the head of the piercing punch 1d are supported slidably in the punching direction by the cylinder 7 fitted in the pad 10 of the upper die, the coil spring 8 for retracting the piercing punch 1d and the plunger 6 is provided in the cylinder 7, and the head of the plunger 6 is pressed by the plate 11 secured to the upper die holder 5a so as to force out the piercing punch 1d.

In the press die for punching a hole in the sheet metal shown in FIG. 4, the plate 11 may be omitted, and the piercing punch 1d may be forced out by directly pressing the head of the plunger 6 by the upper die holder 5a.

To describe the punching by the press die shown in FIG. 4, as the upper die holder 5a is lowered, the pad 10 is brought into contact with a workpiece 4a placed on the piercing die 3b of the lower die 2a, whereupon the pad 10 is held at that position by the lower die 2a with the workpiece 4a interposed therebetween. As the upper die holder 5a is further lowered, the plate 11 secured to the upper die holder 5a is brought into contact with the plunger 6, and as the upper die holder 5a is further lowered, the plunger 6 is pressed, and the piercing punch 1d is also pressed concurrently in a similar manner.

The piercing punch 1d and the plunger 6 are forced out while compressing a pressure source such as the coil spring 8 in a state of being guided by the cylinder 7, and a hole is punched in the workpiece 4a, as described above. After working, as the upper die holder 5a and the pad 10 are raised, the piercing punch 1d and the plunger 6 are returned to the state persisting prior to working by means of the pressure source such as the coil spring 8.

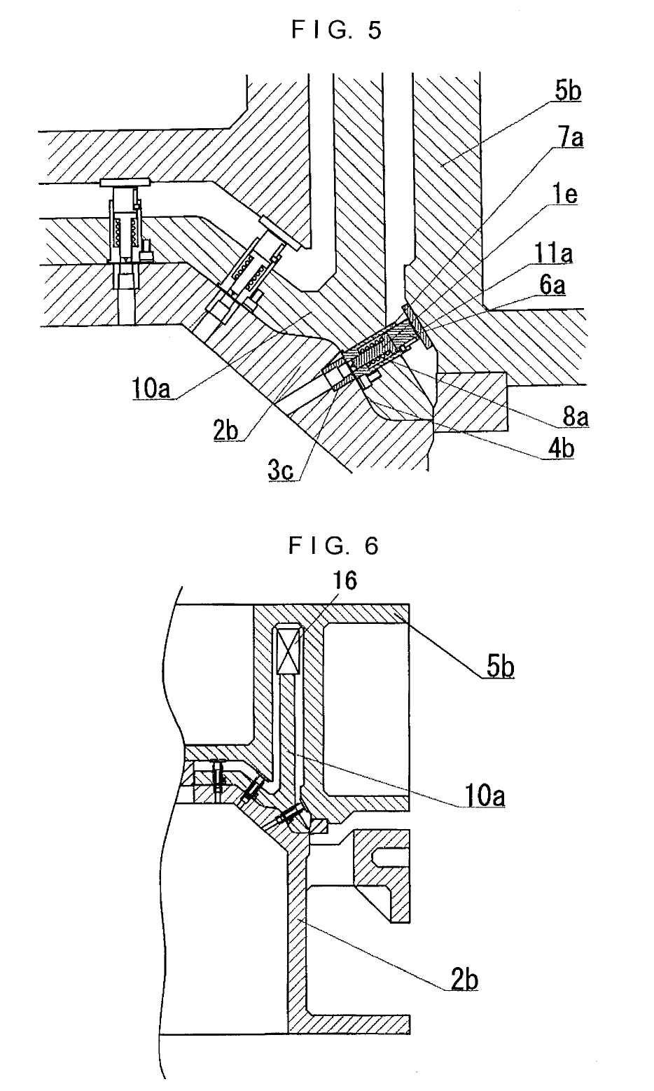

As shown in FIGS. 5 and 6, in a press die for punching a hole in a plate surface of a workpiece 4b which is inclined with respect to the rising and lowering directions of an upper die holder 5b (pressing direction), a piercing die 3c is buried in an inclined surface of a lower die 2b in a direction perpendicular to that inclined surface. In addition, the above-described punch unit is fitted in a main body pad 10a in a direction in which the punch unit opposes the piercing die 3c.

As the upper die holder (press slide) 5b is lowered, after the pad 10a is first brought into contact with the workpiece 4b placed on the lower die 2b, the position of the pad 10a with respect to the lower die 2b is maintained although there is some variation. As the upper die holder 5b is further lowered, a plate 11a secured to the upper die holder 5b is brought into contact with a plunger 6a, whereupon the plunger 6a is guided and pressed in a direction perpendicular to the inclined surface by a cylinder 7a, and presses a piercing punch 1e concurrently. As the upper die holder 5b is further lowered, the piercing punch 1e and the plunger 6a are forced out while compressing a pressure source such as a coil spring 8a. At this time, since a hole is punched in the workpiece 4b in the same way as described above, even if variation occurs in the position of the pad 10a relative to the lower die 2b, a high-quality hole is punched. After working, as the upper die holder 5b and the pad 10a are raised, the piercing punch 1e and the plunger 6a are returned to the state persisting prior to working by means of the pressure source such as the coil spring 8a. In the above-described manner, a hole is formed in the plate surface of the workpiece 4b having an inclination relative to the direction in which the workpiece 4b is pressed.

What is claimed is:

1. A punch unit for a press die for punching a hole in sheet metal, comprising:
a piercing punch provided with a sharp projection;
a plunger for pressing said piercing punch;
a cylinder for supporting said piercing punch and said plunger slidably in a punching direction; and
a coil spring for retracting said piercing punch and said plunger.

2. The punch unit according to claim 1, wherein said sharp projection is provided on a surface opposing a piercing die buried in a lower die.

3. The punch unit according to claim 1 or 2, wherein said cylinder is adapted to be fitted in a pad of an upper die.

4. The punch unit according to claim 1 or 2, wherein an outer peripheral edge portion of a tip of said piercing punch provided with said sharp projection is rounded.

5. A press die for punching a hole in sheet metal, comprising:
an upper die having a pad;
a lower die in which a piercing die is buried;
a cylinder fitted in the pad;
a piercing punch supported slidably in a punching direction by the cylinder and disposed in face-to-face relation to the piercing die;
a plunger for pressing a head of the piercing punch, the plunger being supported slidably in the punching direction by the cylinder; and
a coil spring disposed in the cylinder to retract the piercing punch and the plunger,
the plunger having a head pressed by one of an upper die holder and a plate secured to the upper die holder so as to force out the piercing punch.

6. The press die for punching a hole in sheet metal according to claim 5, wherein said piercing die is buried in an inclined surface of said lower die.

7. A method for press punching a hole in sheet metal, comprising the steps of:
causing a workpiece to be pressed by a piercing punch which is held by an upper die and which has a smaller diameter than in a case where it is used in shearing work with respect to a diameter of a hole of a piercing die buried in a lower die, and has at a tip thereof at least one sharp projection for piercing the workpiece, an outer peripheral edge portion of said tip where said sharp projection is provided being rounded, so as to punch a pierced hole in the workpiece by said sharp projection; and
further pressing said piercing punch in a state in which the lateral movement of the workpiece in a hole portion of said piercing die is restricted by said sharp projection and said pierced hole, so as to fracture the workpiece by a peripheral edge portion of said hole portion of said piercing die, thereby forming in the workpiece a hole having substantially the same configuration as that of said hole of said piercing die.

8. The method for press punching a hole in sheet metal according to claim 7, further comprising the step of:
forming a hole in a plate surface of the workpiece having an inclination with respect to a direction in which the workpiece is pressed.
